(19) United States
(12) Patent Application Publication
(10) Pub. No.: US 2022/0243347 A1
(43) Pub. Date: Aug. 4, 2022

(54) DETERMINATION METHOD AND DETERMINATION APPARATUS FOR CONVERSION EFFICIENCY OF HYDROGEN PRODUCTION BY WIND-SOLAR HYBRID ELECTROLYSIS OF WATER

(71) Applicants: Hebei Jiantou new energy Co., Ltd, Shijiazhuang (CN); Hebei university of technology, Tianjin (CN)

(72) Inventors: Tao LIANG, Tianjin (CN); Hexu SUN, Tianjin (CN); Xin CAO, Shijiazhuang (CN); Yan DONG, Tianjin (CN); Tao LIN, Tianjin (CN); Zhaoming LEI, Tianjin (CN); Bin LIU, Tianjin (CN); Wenzhe LIAO, Tianjin (CN); Xiaoliang QIN, Tianjin (CN); Xiaoyang WEI, Shijiazhuang (CN)

(21) Appl. No.: 17/586,741

(22) Filed: Jan. 27, 2022

(30) Foreign Application Priority Data
Jan. 29, 2021 (CN) 202110129235.0

(51) Int. Cl. C25B 15/023; G06N 3/04; C25B 1/04

(52) U.S. Cl. CPC C25B 15/023; C25B 1/04; G06N 3/0445

(57) ABSTRACT

The application provides a determination method and a determination apparatus for conversion efficiency of hydrogen production by wind-solar hybrid electrolysis of water. The method includes that: first test data of a target factor influencing the conversion efficiency of hydrogen production by wind-solar hybrid electrolysis of water is acquired in real time; a neural network model of the conversion efficiency is established; and the conversion efficiency is determined according to the neural network model and the first test data.

### CROSS-REFERENCE TO RELATED APPLICATIONS

The present disclosure takes the Chinese Patent Application No. 202110129235.0, filed on Jan. 29, 2021, and entitled “determination method and determination apparatus for conversion efficiency of hydrogen production by wind-solar hybrid electrolysis of water.

### TECHNICAL FIELD

The application relates to the field of hydrogen production, in particular to a determination method, a determination apparatus, and a determination system for the conversion efficiency of hydrogen production by wind-solar hybrid electrolysis of water, a computer-readable storage medium and a processor.

### BACKGROUND

In the actual production process of wind-solar hybrid hydrogen production, there are many factors that affect the energy conversion efficiency, and it is difficult to describe the conversion efficiency and its influence factors by simple formulas.

At present, during the production of wind power plants, the efficiency is analyzed off-line mostly through energy conversion processes such as wind power conversion, photoelectric conversion and electrolysis of water. These methods are not only low in accuracy, but also have a large delay, and cannot provide guidance for engineers to adjust the real-time operation of power plants accordingly.

Therefore, there is an urgent need for an on-line soft-sensing and energy consumption diagnosis method and system for the energy conversion efficiency of hydrogen production by wind-solar hybrid electrolysis of water.

The above information disclosed in the background section is only used to enhance the understanding of the background of the technology described herein. Therefore, the background can contain some information, which does not form the conventional art known in China for those skilled in the art.

### SUMMARY

The application mainly aims to provide a determination method, a determination apparatus, and a determination system for the conversion efficiency of hydrogen production by wind-solar hybrid electrolysis of water, a computer-readable storage medium and a processor.

According to an aspect of embodiments of the disclosure, a determination method for the conversion efficiency of hydrogen production by wind-solar hybrid electrolysis of water is provided. The method include that: first test data of a target factor influencing the conversion efficiency of hydrogen production by wind-solar hybrid electrolysis of water is acquired in real time; a neural network model of the conversion efficiency is established; and the conversion efficiency is determined according to the neural network model and the first test data.

Optionally, before the first test data of the target factor influencing the conversion efficiency of hydrogen production by wind-solar hybrid electrolysis of water is acquired in real time, the method further include that: a plurality of first historical test data of a plurality of factors influencing the conversion efficiency are acquired; and the target factor among a plurality of the factors is determined by a maximum information coefficient method according to a plurality of the first historical test data.

Optionally, after a plurality of the first historical test data of a plurality of the factors influencing the conversion efficiency are acquired and before the target factor among a plurality of the factors is determined by the maximum information coefficient method according to a plurality of the first historical test data, the method include that: abnormal data in a plurality of the first historical test data is determined by a Grubbs, and the abnormal data is removed; and a plurality of the first historical test data with the abnormal data removed are processed by a wavelet threshold denoising method to obtain a plurality of first predetermined historical data. The operation of determining, according to a plurality of the first historical test data, the target factor among a plurality of the factors by the maximum information coefficient method include that: the target factor is determined by the maximum information coefficient method according to a plurality of the first predetermined historical data.

Optionally, the operation of establishing the neural network model of the conversion efficiency include that: a plurality of second historical test data corresponding to a plurality of the first predetermined historical data are acquired, the second historical test data being the historical data of the conversion efficiency; an initial neural network model is determined according to a plurality of the first predetermined historical data and a plurality of the corresponding second historical test data; it is determined whether the prediction accuracy of the initial neural network model is less than or equal to a predetermined value; and in the case that the prediction accuracy of the initial neural network model is determined to be less than or equal to the predetermined value, the initial neural network model is optimized using an improved locust optimization algorithm until the prediction accuracy of the optimized initial neural network model is greater than the predetermined value, the optimized initial neural network model being the neural network model.

Optionally, after a plurality of the second historical test data corresponding to a plurality of the first predetermined historical data are acquired and before the initial neural network model is determined, the method include that: abnormal data in a plurality of the second historical test data is determined by a Grubbs, and the abnormal data is removed; and a plurality of the second historical test data with the abnormal data removed are processed by a wavelet threshold denoising method to obtain a plurality of second predetermined historical data. The operation of determining the initial neural network model according to a plurality of the first predetermined historical data and a plurality of the corresponding second historical test data include that: the initial neural network model is determined according to a plurality of the first predetermined historical data and a plurality of the corresponding second predetermined historical data.

Optionally, the initial neural network model is a Gated Recurrent Unit (GRU) neural network model.

Optionally, after the conversion efficiency is determined according to the neural network model and the first test data, the method further include that: a plurality of the second predetermined historical data and a plurality of the corresponding first predetermined historical data are processed by a Density-Based Spatial Clustering of Applications with Noise (DBSCAN) algorithm, and a reference value of the target factor and the reference value of the conversion efficiency are determined; the degree of influence of the target factor on the conversion efficiency is determined according to the reference value of the target factor, the reference value of the conversion efficiency, the first test data and the neural network model; and a loss reason of hydrogen production by wind-solar hybrid electrolysis of water is determined according to the degree of influence.

According to another aspect of the embodiments of the disclosure, a determination apparatus for the conversion efficiency of hydrogen production by wind-solar hybrid electrolysis of water is further provided. The apparatus include a first acquisition unit, an establishing unit and a first determination unit. Herein, the first acquisition unit is configured to acquire first test data of a target factor influencing the conversion efficiency of hydrogen production by wind-solar hybrid electrolysis of water in real time; the establishing unit is configured to establish a neural network model of the conversion efficiency; and the first determination unit is configured to determine the conversion efficiency according to the neural network model and the first test data.

According to yet another aspect of the embodiments of the disclosure, a computer-readable storage medium is further provided. The computer-readable storage medium include a stored program. Herein, the program executes any above-mentioned method.

According to still another aspect of the embodiments of the disclosure, a processor is further provided. The processor is configured to run a program. Herein, when running, the program executes any above-mentioned method.

According to yet another aspect of the embodiments of the disclosure, a determination system for conversion efficiency of hydrogen production by wind-solar hybrid electrolysis of water is further provided. The system include a determination apparatus, a database, a terminal and a server. Herein, the determination apparatus is configured to execute any above-mentioned determination method. The database is communicatively connected with the determination apparatus, and the database is configured to provide data for the determination apparatus and store the conversion efficiency generated by the determination apparatus. The terminal is configured to send a request, and the request at least includes a request for acquiring the conversion efficiency of hydrogen production by wind-solar hybrid electrolysis of water. The server is communicatively connected with the terminal and the database respectively, and the server is configured to receive the request, acquire the conversion efficiency from the database according to the request, and send the conversion efficiency to the terminal.

According to the determination method for the conversion efficiency of hydrogen production by wind-solar hybrid electrolysis of water in the application, the first test data of the target factor influencing the conversion efficiency of hydrogen production by wind-solar hybrid electrolysis of water is first acquired in real time; then, the neural network model of the conversion efficiency is established; finally, the conversion efficiency is determined according to the neural network model and the first test data.

In the method, the first test data is input to the neural network model, so that the conversion efficiency of hydrogen production by wind-solar hybrid electrolysis of water can be determined in real time and accurately.

### BRIEF DESCRIPTION OF THE DRAWINGS

The drawings consisting a part of the application are used to provide further understanding of the present application. The schematic embodiments of the application and description thereof are used for explaining the application and do not limit the application improperly. In the drawings,

FIG. 1 illustrates a flowchart generated according to a determination method for conversion efficiency of hydrogen production by wind-solar hybrid electrolysis of water according to an embodiment of the application.

FIG. 2 illustrates a schematic diagram of a comparison result of the conversion efficiency obtained according to an embodiment of the application with measured conversion efficiency.

FIG. 3 illustrates a schematic diagram of a determination apparatus for conversion efficiency of hydrogen production by wind-solar hybrid electrolysis of water according to an embodiment of the application.

FIG. 4 illustrates a schematic diagram of a determination system for conversion efficiency of hydrogen production by wind-solar hybrid electrolysis of water according to an embodiment of the application.

### DETAILED DESCRIPTION OF THE EMBODIMENTS

It is to be noted that the embodiments of the application and the features in the embodiments can be combined with each other without conflict.

The application will be described in detail with reference to the accompanying drawings and embodiments.

In order to enable those skilled in the art to better understand the solutions of the application, the technical solutions in the embodiments of the application will be clearly and completely described below in combination with the drawings in the embodiments of the application, and it is apparent that the described embodiments are only a part rather all of embodiments of the application. All other embodiments obtained by those of ordinary skill in the art based on the embodiments in the application without creative work shall fall within the scope of protection of the application.

It is to be noted that terms “first”, “second”, etc., in the specification, claims, and drawings of the application are adopted not to describe a specific sequence or order but to distinguish similar objects. It is to be understood that data used like this can be interchanged as appropriate such that the embodiments of the application described here can be implemented. In addition, terms “comprise,” “comprising,” “include,” “including,” “has,” “having” or any other variations thereof, are intended to cover a non-exclusive inclusion. For example, a process, method, system, product or device that includes a list of steps or units is not necessarily limited to only those steps or units but include other steps or units not expressly listed or inherent to such process, method, product or device.

It is to be understood that when an element (such as a layer, film, region, or substrate) is described as being “on” another element, the element can be directly on the other element, or there can be an intermediate element. Furthermore, in the specification and claims, when an element is described as being “connected” to another element, the element can be “directly connected” to the other element or “connected” to the other element through a third element.

As mentioned in the background, the off-line analysis of the energy conversion efficiency of electrolysis of water in the conventional art has a large delay. In order to solve the above problem, a determination method, a determination apparatus and a determination system for the conversion efficiency of hydrogen production by wind-solar hybrid electrolysis of water, a computer-readable storage medium and a processor are provided in a typical implementation mode of the application.

A determination method for conversion efficiency of hydrogen production by wind-solar hybrid electrolysis of water is provided according to an embodiment of the application.

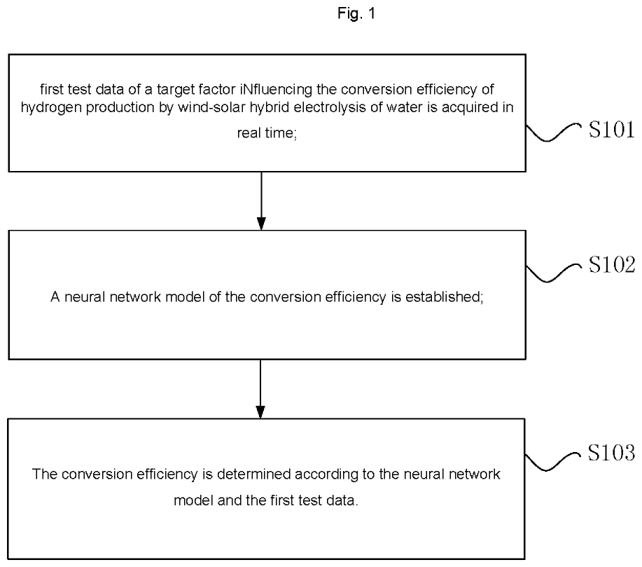

FIG. 1 is a flowchart of a determination method for conversion efficiency of hydrogen production by wind-solar hybrid electrolysis of water according to an embodiment of the application. As shown in FIG. 1, the method includes the following steps.

At S101, first test data of a target factor influencing the conversion efficiency of hydrogen production by wind-solar hybrid electrolysis of water is acquired in real time.

At S102, a neural network model of the conversion efficiency is established.

At S103, the conversion efficiency is determined according to the neural network model and the first test data.

According to the above-mentioned determination method for the conversion efficiency of hydrogen production by wind-solar hybrid electrolysis of water in the application, the first test data of the target factor influencing the conversion efficiency of hydrogen production by wind-solar hybrid electrolysis of water is first acquired in real time; then, the neural network model of the above-mentioned conversion efficiency is established; finally, the above-mentioned conversion efficiency is determined according to the neural network model and the first test data. In the method, the first test data is input to the neural network model, so that the conversion efficiency of hydrogen production by wind-solar hybrid electrolysis of water can be determined in real time and accurately.

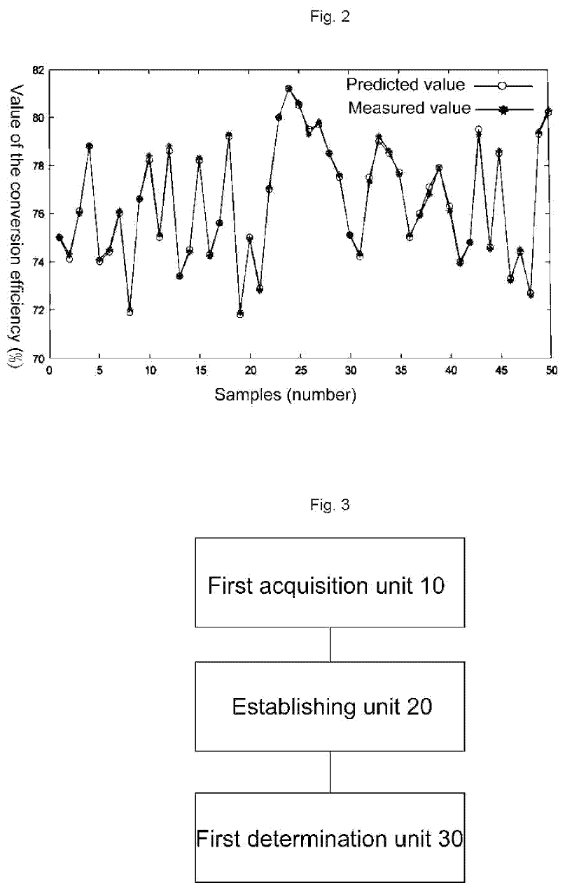

In a specific embodiment, as shown in FIG. 2, a conversion efficiency curve determined by the method of the application is a predicted value curve, and a measured conversion efficiency curve is a measured value curve.

According to a specific embodiment of the application, before the first test data of the target factor influencing the conversion efficiency of hydrogen production by wind-solar hybrid electrolysis of water is acquired in real time, the method further include that: a plurality of first historical test data of a plurality of factors influencing the conversion efficiency are acquired; and the target factor among a plurality of the factors is determined by a maximum information coefficient method according to a plurality of the first historical test data. According to the method, the target factor which has a great influence on the conversion efficiency of hydrogen production by wind-solar hybrid electrolysis of water can be more accurately determined from the above factors by the maximum information coefficient method, which further ensures that the conversion efficiency determined later is more accurate. Meanwhile, the target factor is extracted from a plurality of the factors, which ensures that the determination process of the above method is relatively simple.

In the actual application process, the above factors include wind speed, light intensity, electrode current, hydrogen oxygen content, Direct-Current (DC) microgrid loss, electrolyte concentration, hydrogen water content, battery conversion consumption, hydrogen residue, electrolyte temperature, hydrogen pressure and electrode loss. Certainly, the above factors can also include other factors that affect the conversion efficiency of hydrogen production by wind-solar hybrid electrolysis of water. The target factor among a plurality of the above factors is determined by the maximum information coefficient method to include the wind speed, the light intensity, the electrode current, the hydrogen oxygen content, the DC microgrid loss, the electrolyte concentration, the hydrogen water content, the battery conversion consumption, the electrolyte temperature and the hydrogen pressure.

In a specific embodiment, the step of determining the above-mentioned target factor by the maximum information coefficient method includes the following steps: any two factors X and Y among the above-mentioned factors are selected, i-column and j-row gridding being performed on a scatter diagram constituted by X and Y by given i and j, the maximum mutual information value being calculated, then the obtained maximum mutual information value being normalized, and finally the maximum value of mutual information at different scales being selected as the maximum information coefficient value. The above steps are repeated until the maximum information coefficient value of any two of the above factors is determined, and then the target factor is determined according to the maximum information coefficient value.

In the actual application process, the above-mentioned test data are usually collected by a sensor. Since the sensor is prone to being affected by the changes of external environment, equipment failures and aging, the data collected by the sensor usually have distorted data that deviate from the normal level. These distorted data are called abnormal points, and the existence of the abnormal points will greatly affect feature extraction and the accuracy of the above-mentioned conversion efficiency. In such a case, in order to further ensure that the above-mentioned conversion efficiency is more accurate in this case, in another specific embodiment of the application, after a plurality of the first historical test data of a plurality of the factors influencing the conversion efficiency are acquired and before the target factor among a plurality of the factors is determined by the maximum information coefficient method according to a plurality of the first historical test data, the method includes that: abnormal data in a plurality of the first historical test data is determined by a Grubbs, and the abnormal data is removed; and a plurality of the first historical test data with the abnormal data removed are processed by a wavelet threshold denoising method to obtain a plurality of first predetermined historical data. The operation of determining, according to a plurality of the first historical test data, the target factor among a plurality of the factors by the maximum information coefficient method includes that: the target factor is determined by the maximum information coefficient method according to a plurality of the first predetermined historical data.

In the actual application process, the step of obtaining a plurality of the first predetermined historical data includes the steps that: aiming at a plurality of the first historical test data, taking every adjacent 15 first historical test data as a unit, the data in each unit are sorted from small to large, the average value of the unit being obtained by calculating the data in each unit, the average value X and a standard deviation δ of the data in the unit being calculated, and it being compulsory for the calculation process to include all the data in the unit; deviation values can be obtained by calculating the differences between the average value and the maximum and minimum values, and a doubtful value can be determined by comparing the deviation values; Gᵢ=(Xᵢ−X)/δ is calculated, where i is the serial number of the doubtful value; if the value Gᵢ is greater than a critical value GP(n), this value is the abnormal value and will be rejected; and the noise which is aliased in the data due to environmental changes and equipment aging is eliminated by a wavelet transform threshold denoising method.

In the actual application process, the above-mentioned data are generally collected by the sensor, which has a large data amount, various external factors and sensor accuracy problems. Therefore, analysis processing on each of the above-mentioned collected data will lead to a large workload and is prone to errors.

According to still another embodiment of the application, the step of establishing the neural network model of the conversion efficiency includes that: a plurality of second historical test data corresponding to a plurality of the first predetermined historical data are acquired, the second historical test data being the historical data of the conversion efficiency; an initial neural network model is determined according to a plurality of the first predetermined historical data and a plurality of the corresponding second historical test data; it is determined whether the prediction accuracy of the initial neural network model is less than or equal to a predetermined value; and in the case that the prediction accuracy of the initial neural network model is determined to be less than or equal to the predetermined value, the initial neural network model is optimized using an improved locust optimization algorithm until the prediction accuracy of the optimized initial neural network model is greater than the predetermined value, the optimized initial neural network model being the neural network model.

In a specific embodiment of the application, the step of improving an locust optimization algorithm to obtain the improved locust optimization algorithm includes the steps that: at S1, parameters such as population size, maximum iteration times and change range of a position of the locust optimization algorithm are initialized, and a fitness function is determined; at S2, the position of a first generation population is initialized: a Latin hypercube sampling method is optimized using a FORMULA criterion, so as to improve the population initialization process, so that it can be uniformly distributed in a solution space; at S3, fitness values of all locust individuals are calculated according to to-be-optimized problems, and the position of the individual with the best fitness is recorded and saved; at S4, the position of each locust individual is updated using the chaotic parameters, and then a mutation operator is added in combination with the differential evolution idea to get the updated final position of this generation of individuals; and the third step and the fourth step are repeated to constantly update the positions of all the individuals, and the updated position of an optimal individual is saved until the end of iteration.

According to still another specific embodiment of the application, the step of optimizing the initial neural network model using the improved locust optimization algorithm includes the steps that: at S1, individual initialization is performed: firstly, the position of the first generation population is initialized by a random method, that is, the parameter combination of (s, η) is initialized. At S2, individual fitness is calculated: a Root Mean Squared Error (RMSE) between an output value of model training and an actual value is selected as an objective function of optimizing, that is, the fitness of each individual in the population. Each fitness is calculated separately, the individual with the minimum value is selected as the optimal individual, and the corresponding optimal model parameters are recorded. At S3, the position of the optimal individual is updated: the position of each locust individual is updated, and the fitness of each individual is recalculated and compared with all other individuals. If a new individual with the best fitness is generated, the position of the individual is taken as a new optimal position, and the corresponding model parameters are recorded. At S4, the two steps of S2 and S3 are repeated until the end of iteration, and the optimal parameter combination of the model is obtained from the optimal individual position.

In yet another specific embodiment of the application, after a plurality of the second historical test data corresponding to a plurality of the first predetermined historical data are acquired and before the initial neural network model is determined, the method further includes that: abnormal data in a plurality of the second historical test data is determined by a Grubbs, and the abnormal data is removed; and a plurality of the second historical test data with the abnormal data removed are processed by a wavelet threshold denoising method to obtain a plurality of second predetermined historical data. The operation of determining the initial neural network model according to a plurality of the first predetermined historical data and a plurality of the corresponding second historical test data includes that: the initial neural network model is determined according to a plurality of the first predetermined historical data and a plurality of the corresponding second predetermined historical data.

In order to further ensure the prediction accuracy of the neural network model to be better and further ensure to obtain the more accurate conversion efficiency, the initial neural network model is a GRU neural network model in the actual application process. Certainly, the above initial neural network model can also be other types of neural network models, such as a Back Propagation (BP) neural network model and a Hopfield network model.

The above-mentioned GRU neural network model belongs to a kind of Recurrent Neural Networks (RNNs). “Gate” is a mechanism to control information flow, including a sigmoid function and a multiplication operation. In an actual GRU, the data can be transformed into numerical outputs in a range of (0,1) through the sigmoid function, thus serving as a gating signal. For a GRU network model, the setting of an initial weight has an important influence on the training time and whether to converge or not, and also has an important influence on whether falling into local optimum. The dimension of a weight matrix and the result of initialization are related to the number of nodes in an input layer, a hidden layer and an output layer. Since the number of nodes in the input layer and the output layer are the input and output of predicted data respectively, and the number of nodes in the hidden layer and the weight learning rate have an important influence on the accuracy of the prediction result, the number of nodes s in the hidden layer and the weight coefficient learning rate η are selected as to-be-optimized parameters.

According to yet another specific embodiment of the application, after the conversion efficiency is determined according to the neural network model and the first test data, the method further includes that: a plurality of the second predetermined historical data and a plurality of the corresponding first predetermined historical data are processed by a DBSCAN algorithm, and a reference value of the target factor and the reference value of the conversion efficiency are determined; the degree of influence of the target factor on the conversion efficiency is determined according to the reference value of the target factor, the reference value of the conversion efficiency, the first test data and the neural network model; and a loss reason of hydrogen production by wind-solar hybrid electrolysis of water is determined according to the degree of influence.

In a specific embodiment, after the reference value of the target factor and the reference value of the conversion efficiency are determined, and before the degree of influence of the target factor on the conversion efficiency is determined, the method further includes that: curve fitting is performed on the reference values of the target factor for hydrogen production by electrolysis of water under different working modes, and curve fitting is performed on the reference values of the conversion efficiency of hydrogen production by electrolysis of water under different working modes to obtain the reference values of the target factor and the reference values of the conversion efficiency under all working conditions.

In a specific embodiment, taking the calculation of the variation quantity of the conversion efficiency corresponding to the electrolyte temperature as an example, the operation of determining the degree of influence of the target factor on the conversion efficiency according to the reference value of the target factor, the reference value of the conversion efficiency, the first test data and the neural network model includes: the reference value of the conversion efficiency b₀=g(x₁, x₂, . . . , xₙ), where g(x₁, x₂, . . . , xₙ) is an energy conversion efficiency prediction model, xₙ is the reference value of the target factor. The variation quantity of the conversion efficiency corresponding to the electrolyte temperature T_{Z} is: Δb_{T}_{₂}=b₀−b_{T}_{₂}, b_{T}_{_{Z}}=g(x₁, T_{Z}, . . . , xₙ), where T_{Z}=110% x₂ is numerically equal to 10% increase of the reference value of the electrolyte temperature, that is, only the input value of the target factor of electrolyte temperature variation is considered, and other target factors are brought into the reference value. From this, the degree of influence of each target factor on the conversion efficiency is obtained.

In the actual application process, the conversion efficiency determined by the neural network model can be compared with the reference value of the conversion efficiency, and the first test data of each target factor is compared with the reference value of the target factor, so that the loss reason of the conversion efficiency can be determined in combination with the degree of influence.

It should be noted that the steps presented in the flowchart of the drawings can be executed in a computer system like a group of computer executable instructions, and moreover, although a logical order is shown in the flow chart, in some cases, the presented or described steps can be performed in an order different from that described here.

The embodiments of the application also provide a determination apparatus for the conversion efficiency of hydrogen production by wind-solar hybrid electrolysis of water. It is to be noted that the determination apparatus for the conversion efficiency of hydrogen production by wind-solar hybrid electrolysis of water can be used to implement the determination method for the conversion efficiency of hydrogen production by wind-solar hybrid electrolysis of water provided by the embodiments of the application. Introductions are made below for the determination apparatus for the conversion efficiency of hydrogen production by wind-solar hybrid electrolysis of water according to the embodiments of the application.

FIG. 3 is a schematic diagram of a determination apparatus for conversion efficiency of hydrogen production by wind-solar hybrid electrolysis of water according to an embodiment of the application. As shown in FIG. 3, the apparatus includes a first acquisition unit 10, an establishing unit 20 and a first determination unit 30. Herein, the first acquisition unit 10 is configured to acquire first test data of a target factor influencing the conversion efficiency of hydrogen production by wind-solar hybrid electrolysis of water in real time; the establishing unit 20 is configured to establish a neural network model of the conversion efficiency; and the first determination unit 30 is configured to determine the conversion efficiency according to the neural network model and the first test data.

According to the above-mentioned determination apparatus for the conversion efficiency of hydrogen production by wind-solar hybrid electrolysis of water in the application, the first test data of the target factor influencing the conversion efficiency of hydrogen production by wind-solar hybrid electrolysis of water is acquired in real time by the first acquisition unit; the neural network model of the above-mentioned conversion efficiency is established by the establishing unit; and the above-mentioned conversion efficiency is determined according to the neural network model and the first test data by the first determination unit. In the apparatus, the first test data is input to the neural network model, so that the conversion efficiency of hydrogen production by wind-solar hybrid electrolysis of water can be determined in real time and accurately, thus effectively solving the problem of large delay caused by off-line analysis of the conversion efficiency in the conventional art, and facilitating workers to determine the real-time operation of a power plant according to the conversion efficiency determined in real time.

In a specific embodiment, as shown in FIG. 2, a conversion efficiency curve determined by the method of the application is a predicted value curve, and a measured conversion efficiency curve is a measured value curve. It is to be seen from the figure that the conversion efficiency determined by the method of the application is basically consistent with the measured conversion efficiency, with high accuracy.

According to a specific embodiment of the application, the apparatus further includes a second acquisition unit and a second determination unit. Herein, the second acquisition unit is configured to acquire a plurality of first historical test data of a plurality of factors influencing the conversion efficiency before acquiring the first test data of the target factor influencing the conversion efficiency of hydrogen production by wind-solar hybrid electrolysis of water in real time; and the second determination unit is configured to determine the target factor among a plurality of the factors by a maximum information coefficient method according to a plurality of the first historical test data. According to the apparatus, the target factor which has a great influence on the conversion efficiency of hydrogen production by wind-solar hybrid electrolysis of water can be more accurately determined from the above factors by the maximum information coefficient method, which further ensures that the conversion efficiency determined later is more accurate. Meanwhile, the target factor is extracted from a plurality of the factors, which ensures that the determination process of the above apparatus is relatively simple.

In the actual application process, the above factors include wind speed, light intensity, electrode current, hydrogen oxygen content, DC microgrid loss, electrolyte concentration, hydrogen water content, battery conversion consumption, hydrogen residue, electrolyte temperature, hydrogen pressure and electrode loss. Certainly, the above factors can also include other factors that affect the conversion efficiency of hydrogen production by wind-solar hybrid electrolysis of water. The target factor among a plurality of the above factors is determined by the maximum information coefficient method to include the wind speed, the light intensity, the electrode current, the hydrogen oxygen content, the DC microgrid loss, the electrolyte concentration, the hydrogen water content, the battery conversion consumption, the electrolyte temperature and the hydrogen pressure. Certainly, those skilled in the art can also use other algorithms in the conventional art to determine the target factor from the above factors.

In a specific embodiment, the step of determining the above-mentioned target factor by the maximum information coefficient method includes the following steps: any two factors X and Y among the above-mentioned factors are selected, i-column and j-row gridding being performed on a scatter diagram constituted by X and Y by given i and j, the maximum mutual information value being calculated, then the obtained maximum mutual information value being normalized, and finally the maximum value of mutual information at different scales being selected as the maximum information coefficient value. The above steps are repeated until the maximum information coefficient value of any two of the above factors is determined, and then the target factor is determined according to the maximum information coefficient value.

In the actual application process, the above-mentioned test data are usually collected by a sensor. Since the sensor is prone to being affected by the changes of external environment, equipment failures and aging, the data collected by the sensor usually have distorted data that deviate from the normal level. These distorted data are called abnormal points, and the existence of the abnormal points will greatly affect feature extraction and the accuracy of the above-mentioned conversion efficiency. In such a case, in order to further ensure that the above-mentioned conversion efficiency is more accurate in this case, in another specific embodiment of the application, the apparatus includes a third determination unit and a first processing unit. Herein, the third determination unit is configured to determine abnormal data in a plurality of the first historical test data by a Grubbs and remove the abnormal data after acquiring a plurality of the first historical test data of a plurality of the factors influencing the conversion efficiency and before determining the target factor among a plurality of the factors by the maximum information coefficient method according to a plurality of the first historical test data. The first processing unit is configured to process a plurality of the first historical test data with the abnormal data removed by a wavelet threshold denoising method to obtain a plurality of first predetermined historical data. The second determination unit includes a first determination module. The first determination module is configured to determine the target factor by the maximum information coefficient method according to a plurality of the first predetermined historical data. According to the above apparatus, an abnormal value in a plurality of the first historical test data is determined, and denoising is performed after the abnormal value is removed, so that the problem of low accuracy of the collected data caused by environmental changes, equipment aging and other reasons is alleviated, a plurality of the obtained first predetermined historical data are ensured to be more accurate, the determined target factor is further ensured to be more accurate, and the conversion efficiency determined later is further ensured to be more accurate.

In the actual application process, the step of obtaining a plurality of the first predetermined historical data includes the steps that: aiming at a plurality of the first historical test data, taking every adjacent 15 first historical test data as a unit, the data in each unit are sorted from small to large, the average value of the unit being obtained by calculating the data in each unit, the average value X and a standard deviation δ of the data in the unit being calculated, and it being compulsory for the calculation process to include all the data in the unit; deviation values can be obtained by calculating the differences between the average value and the maximum and minimum values, and a doubtful value can be determined by comparing the deviation values; Gᵢ=(Xᵢ−X)/δ is calculated, where i is the serial number of the doubtful value; if the value Gᵢ is greater than a critical value GP(n), this value is the abnormal value and will be rejected; and the noise which is aliased in the data due to environmental changes and equipment aging is eliminated by a wavelet transform threshold denoising method.

In the actual application process, the above-mentioned data are generally collected by the sensor, which has a large data amount, various external factors and sensor accuracy problems. Therefore, analysis processing on each of the above-mentioned collected data will lead to a large workload and is prone to errors. At this time, after the abnormal value is removed, the above-mentioned data around the same time can be combined to be regarded as one piece of data before the wavelet transform threshold denoising method is used, thus greatly reducing possible errors and reducing the workload of data processing at the same time.

According to still another embodiment of the application, the establishing unit includes an acquisition module, a second determination module, a third determination module and an optimization module. Herein, the acquisition module is configured to acquire a plurality of second historical test data corresponding to a plurality of the first predetermined historical data, the second historical test data being the historical data of the conversion efficiency; the second determination module is configured to determine an initial neural network model according to a plurality of the first predetermined historical data and a plurality of the corresponding second historical test data; the third determination module is configured to determine whether the prediction accuracy of the initial neural network model is less than or equal to a predetermined value; and the optimization module is configured to optimize, in the case that the prediction accuracy of the initial neural network model is determined to be less than or equal to the predetermined value, the initial neural network model using an improved locust optimization algorithm until the prediction accuracy of the optimized initial neural network model is greater than the predetermined value, the optimized initial neural network model being the neural network model. Thus, the established neural network model is ensured to be more accurate, and further, the accuracy of the conversion efficiency determined later is ensured to be higher.

In a specific embodiment of the application, the step of improving an locust optimization algorithm to obtain the improved locust optimization algorithm includes the steps that: at S1, parameters such as population size, maximum iteration times and change range of a position of the locust optimization algorithm are initialized, and a fitness function is determined; at S2, the position of a first generation population is initialized: a Latin hypercube sampling apparatus is optimized using a ϕₙ criterion, so as to improve the population initialization process, so that it can be uniformly distributed in a solution space; at S3, fitness values of all locust individuals are calculated according to to-be-optimized problems, and the position of the individual with the best fitness is recorded and saved; at S4, the position of each locust individual is updated using the chaotic parameters, and then a mutation operator is added in combination with the differential evolution idea to get the updated final position of this generation of individuals; and the third step and the fourth step are repeated to constantly update the positions of all the individuals, and the updated position of an optimal individual is saved until the end of iteration. Certainly, the process that the locust optimization algorithm is improved to obtain the improved locust optimization algorithm is not limited to the above process, but can also be any improvement process in the conventional art.

According to still another specific embodiment of the application, the step of optimizing the initial neural network model using the improved locust optimization algorithm includes the steps that: at S1, individual initialization is performed: firstly, the position of the first generation population is initialized by a random method, that is, the parameter combination of (s, η) is initialized. At S2, individual fitness is calculated: a RMSE between an output value of model training and an actual value is selected as an objective function of optimizing, that is, the fitness of each individual in the population. Each fitness is calculated separately, the individual with the minimum value is selected as the optimal individual, and the corresponding optimal model parameters are recorded. At S3, the position of the optimal individual is updated: the position of each locust individual is updated, and the fitness of each individual is recalculated and compared with all other individuals. If a new individual with the best fitness is generated, the position of the individual is taken as a new optimal position, and the corresponding model parameters are recorded. At S4, the two steps of S2 and S3 are repeated until the end of iteration, and the optimal parameter combination of the model is obtained from the optimal individual position.

In yet another specific embodiment of the application, the apparatus further includes a fourth determination unit and a second processing unit. Herein, the fourth determination unit is configured to determine abnormal data in a plurality of the second historical test data by a Grubbs and remove the abnormal data after a plurality of the second historical test data corresponding to a plurality of the first predetermined historical data are acquired and before the initial neural network model is determined. The second processing unit is configured to process a plurality of the second historical test data with the abnormal data removed by a wavelet threshold denoising method to obtain a plurality of second predetermined historical data. The second determination module includes a first determination sub-module. The first determination sub-module is configured to determine the initial neural network model according to a plurality of the first predetermined historical data and a plurality of the corresponding second predetermined historical data. According to the above apparatus, an abnormal value in a plurality of the second historical test data is determined, and denoising is performed after the abnormal value is removed, so that the problem of low accuracy of the collected data caused by environmental changes, equipment aging and other reasons is alleviated, a plurality of the obtained second predetermined historical data are ensured to be more accurate, the established neural network model is further ensured to be more accurate, and the conversion efficiency determined later is further ensured to be more accurate.

In order to further ensure the prediction accuracy of the neural network model to be better and further ensure to obtain the more accurate conversion efficiency, the initial neural network model is a GRU neural network model in the actual application process. Certainly, the above initial neural network model can also be other types of neural network models, such as a BP neural network model and a Hopfield network model.

The above-mentioned GRU neural network model belongs to a kind of RNNs. “Gate” is a mechanism to control information flow, including a sigmoid function and a multiplication operation. In an actual GRU, the data can be transformed into numerical outputs in a range of (0,1) through the sigmoid function, thus serving as a gating signal. For a GRU network model, the setting of an initial weight has an important influence on the training time and whether to converge or not, and also has an important influence on whether falling into local optimum. The dimension of a weight matrix and the result of initialization are related to the number of nodes in an input layer, a hidden layer and an output layer. Since the number of nodes in the input layer and the output layer are the input and output of predicted data respectively, and the number of nodes in the hidden layer and the weight learning rate have an important influence on the accuracy of the prediction result, the number of nodes s in the hidden layer and the weight coefficient learning rate η are selected as to-be-optimized parameters.

According to yet another specific embodiment of the application, the apparatus further includes a third processing unit, a fifth determination unit and a sixth determination unit. Herein, the third processing unit is configured to process, after the conversion efficiency is determined according to the neural network model and the first test data, a plurality of the second predetermined historical data and a plurality of the corresponding first predetermined historical data by a DBSCAN algorithm, and determine a reference value of the target factor and the reference value of the conversion efficiency. The fifth determination unit is configured to determine the degree of influence of the target factor on the conversion efficiency according to the reference value of the target factor, the reference value of the conversion efficiency, the first test data and the neural network model. The sixth determination unit is configured to determine a loss reason of hydrogen production by wind-solar hybrid electrolysis of water according to the degree of influence. Thus, the degree of influence of the above target factor on the above conversion efficiency can be determined more accurately, so as to determine the loss reason of hydrogen production by wind-solar hybrid electrolysis of water more accurately, which can effectively help workers to purposefully perform process optimization.

In a specific embodiment, the apparatus further includes a fitting unit. The fitting unit is configured to perform, after the reference value of the target factor and the reference value of the conversion efficiency are determined, and before the degree of influence of the target factor on the conversion efficiency is determined, curve fitting on the reference values of the target factor for hydrogen production by electrolysis of water under different working modes, and perform curve fitting on the reference values of the conversion efficiency of hydrogen production by electrolysis of water under different working modes to obtain the reference values of the target factor and the reference values of the conversion efficiency under all working conditions. When a large amount of data information is processed, a smooth curve can be obtained by curve fitting, and subsequently the relationship between variables and the changing trend are found out, so as to obtain a curve fitting expression of the reference value, which facilitates subsequent determination of the reference value according to the above expression.

In a specific embodiment, taking the calculation of the variation quantity of the conversion efficiency corresponding to the electrolyte temperature as an example, the operation of determining the degree of influence of the target factor on the conversion efficiency according to the reference value of the target factor, the reference value of the conversion efficiency, the first test data and the neural network model includes: the reference value of the conversion efficiency b₀=g(x₁, x₂, . . . , xₙ), where g(x₁, x₂, . . . , xₙ) is an energy conversion efficiency prediction model, and xₙ is the reference value of the target factor. The variation quantity of the conversion efficiency corresponding to the electrolyte temperature T_{Z} is: Δb_{T}_{_{Z}}=b₀−b_{T}_{_{Z}}, b_{T}_{_{Z}}=g(x₁, T_{Z}, . . . , xₙ), where T_{Z}=110% x₂ is numerically equal to 10% increase of the reference value of the electrolyte temperature, that is, only the input value of the target factor of electrolyte temperature variation is considered, and other target factors are brought into the reference value. From this, the degree of influence of each target factor on the conversion efficiency is obtained.

In the actual application process, the conversion efficiency determined by the neural network model can be compared with the reference value of the conversion efficiency, and the first test data of each target factor is compared with the reference value of the target factor, so that the loss reason of the conversion efficiency can be determined in combination with the degree of influence.

The determination apparatus for the conversion efficiency of hydrogen production by wind-solar hybrid electrolysis of water includes a processor and a memory. The above-mentioned first acquisition unit, the establishing unit, the first determination unit and the like are stored in the memory as program units, and the above-mentioned program units stored in the memory are executed by the processor so as to implement the corresponding functions.

The processor includes a kernel, which can call the corresponding program unit in the memory. One or more kernels can be set, and the problem of large delay in off-line analysis of the energy conversion efficiency of electrolysis of water in the conventional art can be solved by adjusting kernel parameters.

The memory can include forms of a volatile memory in a computer-readable medium, a Random Access Memory (RAM) and/or a volatile memory and the like, such as a Read-Only Memory (ROM) or a flash RAM, and the memory includes at least one storage chip.

The embodiments of the application provide a computer readable storage medium, on which a program is stored. When executed by a processor, the program implements the determination method for the conversion efficiency of hydrogen production by wind-solar hybrid electrolysis of water.

The embodiments of the disclosure provide a processor. The processor is configured to run a program. Herein, when running, the program executes the determination method for the conversion efficiency of hydrogen production by wind-solar hybrid electrolysis of water.

According to yet another typical embodiment of the application, a determination system for conversion efficiency of hydrogen production by wind-solar hybrid electrolysis of water is further provided. The system includes a determination apparatus, a database, a terminal and a server. Herein, the determination apparatus is configured to execute any above-mentioned determination method. The database is communicatively connected with the determination apparatus, and the database is configured to provide data for the determination apparatus and store the conversion efficiency generated by the determination apparatus. The terminal is configured to send a request, and the request at least includes a request for acquiring the conversion efficiency of hydrogen production by wind-solar hybrid electrolysis of water. The server is communicatively connected with the terminal and the database respectively, and the server is configured to receive the request, acquire the conversion efficiency from the database according to the request, and send the conversion efficiency to the terminal.

The determination system for conversion efficiency of hydrogen production by wind-solar hybrid electrolysis of water of the application includes a determination apparatus, a database, a terminal and a server. Herein, the determination apparatus is configured to execute any above-mentioned determination method. The database is configured to provide data for the determination apparatus and store the conversion efficiency generated by the determination apparatus. The terminal is configured to send a request for acquiring the conversion efficiency of hydrogen production by wind-solar hybrid electrolysis of water. The server is configured to receive the request, acquire the conversion efficiency from the database according to the request, and send the conversion efficiency to the terminal. The determination system can determine the conversion efficiency of hydrogen production by wind-solar hybrid electrolysis of water in real time and accurately and displays same on the terminal, thus effectively solving the problem of large delay caused by off-line analysis of the conversion efficiency in the conventional art, and facilitating workers to determine the real-time operation of a power plant according to the conversion efficiency determined in real time.

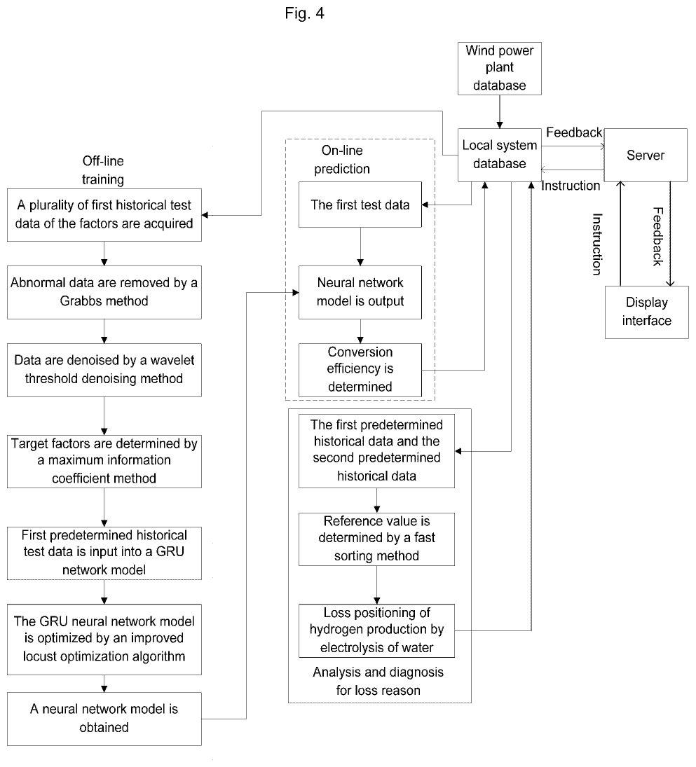

FIG. 4 is a schematic diagram of the above-mentioned system of the application. Herein, the above-mentioned database includes a wind power plant database and a local system database. The above-mentioned terminal is a display interface. The above-mentioned server is a Web server. The above-mentioned local system database is in communication connection with the above-mentioned determination apparatus and the above-mentioned server respectively. The above-mentioned server is configured to receive the above-mentioned request from the terminal, perform logic processing on the above-mentioned request, and then acquire the above-mentioned conversion efficiency from the above-mentioned local system database according to the logically processed request.

The embodiments of the disclosure provide a device, which includes a processor, a memory and a program stored on the memory and being capable of running on the processor. When the processor executes the program, at least the following steps are implemented.

At S101, first test data of a target factor influencing the conversion efficiency of hydrogen production by wind-solar hybrid electrolysis of water is acquired in real time.

At S102, a neural network model of the conversion efficiency is established.

At S103, the conversion efficiency is determined according to the neural network model and the first test data.

The device herein can be a server, a Personal Computer (PC), a PAD, a mobile phone, etc.

The application further provides a computer program product, which is suitable for executing a program of initializing at least the following method steps when executed on a data processing device.

At S101, first test data of a target factor influencing the conversion efficiency of hydrogen production by wind-solar hybrid electrolysis of water is acquired in real time.

At S102, a neural network model of the conversion efficiency is established.

At S103, the conversion efficiency is determined according to the neural network model and the first test data.

In the above-mentioned embodiments of the disclosure, the descriptions of each embodiment have their own emphasis, and the parts that are not detailed in one embodiment can be referred to the related descriptions of other embodiments.

In the several embodiments provided in the application, it is to be understood that the disclosed technical content can be implemented in other manners.

The apparatus embodiment described above is only schematic, and for example, division of the units is only logic function division, and other division manners can be adopted during practical implementation. For example, multiple units or components can be combined or integrated into another system, or some characteristics can be neglected or not executed. In addition, coupling or direct coupling or communication connection between each displayed or discussed component can be indirect coupling or communication connection, implemented through some interfaces, of the units or the modules, and can be electrical or adopt other forms.

The units described as separate parts can or can not be physically separate, and parts displayed as units can or can not be physical units, can be located in one position, or can be distributed on a plurality of units. Part or all of the units can be selected to achieve the purposes of the solutions of the embodiments according to a practical requirement.

In addition, each function unit in each embodiment of the disclosure can be integrated into a first processing unit, or each unit can exist independently, or two or more than two units can also be integrated into a unit. The integrated unit can be implemented in a hardware form and can also be implemented in form of software functional unit.

When being implemented in form of software functional unit and sold or used as an independent product, the integrated unit can be stored in a computer-readable storage medium. Based on such an understanding, the technical solutions of the disclosure substantially or parts making contributions to the conventional art or all or part of the technical solutions can be embodied in form of software product. The computer software product is stored in a storage medium, including a plurality of instructions configured to enable a computer device (which can be a personal computer, a server, a network device, etc.) to execute all or part of the steps of the method in each embodiment of the disclosure. The above-mentioned storage medium includes: various media capable of storing program codes such as a U disk, a Read-Only Memory (ROM), a Random Access Memory (RAM), a mobile hard disk, a magnetic disk, or an optical disk.

It is to be seen from the above descriptions that the above-mentioned embodiments of the application have achieved the following technical effects.

1) According to the above-mentioned determination method for the conversion efficiency of hydrogen production by wind-solar hybrid electrolysis of water in the application, the first test data of the target factor influencing the conversion efficiency of hydrogen production by wind-solar hybrid electrolysis of water is first acquired in real time; then, the neural network model of the above-mentioned conversion efficiency is established; finally, the above-mentioned conversion efficiency is determined according to the neural network model and the first test data. In the method, the first test data is input to the neural network model, so that the conversion efficiency of hydrogen production by wind-solar hybrid electrolysis of water can be determined in real time and accurately, thus effectively solving the problem of large delay caused by off-line analysis of the conversion efficiency in the conventional art, and facilitating workers to determine the real-time operation of a power plant according to the conversion efficiency determined in real time.

2) According to the above-mentioned determination apparatus for the conversion efficiency of hydrogen production by wind-solar hybrid electrolysis of water in the application, the first test data of the target factor influencing the conversion efficiency of hydrogen production by wind-solar hybrid electrolysis of water is acquired in real time by the first acquisition unit; the neural network model of the above-mentioned conversion efficiency is established by the establishing unit; and the above-mentioned conversion efficiency is determined according to the neural network model and the first test data by the first determination unit. In the apparatus, the first test data is input to the neural network model, so that the conversion efficiency of hydrogen production by wind-solar hybrid electrolysis of water can be determined in real time and accurately, thus effectively solving the problem of large delay caused by off-line analysis of the conversion efficiency in the conventional art, and facilitating workers to determine the real-time operation of a power plant according to the conversion efficiency determined in real time.

3) The determination system for the conversion efficiency of hydrogen production by wind-solar hybrid electrolysis of water of the application includes a determination apparatus, a database, a terminal and a server. Herein, the determination apparatus is configured to execute any above-mentioned determination method. The database is configured to provide data for the determination apparatus and store the conversion efficiency generated by the determination apparatus. The terminal is configured to send a request for acquiring the conversion efficiency of hydrogen production by wind-solar hybrid electrolysis of water. The server is configured to receive the request, acquire the conversion efficiency from the database according to the request, and send the conversion efficiency to the terminal. The determination system can determine the conversion efficiency of hydrogen production by wind-solar hybrid electrolysis of water in real time and accurately and displays same on the terminal, thus effectively solving the problem of large delay caused by off-line analysis of the conversion efficiency in the conventional art, and facilitating workers to determine the real-time operation of a power plant according to the conversion efficiency determined in real time.

The above is only the preferred embodiments of the application and is not used to limit the application. For those skilled in the art, there can be various changes and variations in the application. Any modifications, equivalent replacements, improvements and the like made within the spirit and principle of the application shall fall within the scope of protection of the application.

What claimed is:

1. A determination method for conversion efficiency of hydrogen production by wind-solar hybrid electrolysis of water, comprising:
acquiring first test data of a target factor influencing the conversion efficiency of the hydrogen production by the wind-solar hybrid electrolysis of the water in real time;
establishing a neural network model of the conversion efficiency; and
determining the conversion efficiency according to the neural network model and the first test data.

2. The method of claim 1, before acquiring the first test data of the target factor influencing the conversion efficiency of the hydrogen production by the wind-solar hybrid electrolysis of the water in real time, further comprising:
acquiring a plurality of first historical test data of a plurality of factors influencing the conversion efficiency; and
determining, according to the plurality of the first historical test data, the target factor among a plurality of factors by a maximum information coefficient method.

3. The method of claim 2, wherein
after acquiring the plurality of the first historical test data of the plurality of the factors influencing the conversion efficiency and before determining, according to the plurality of the first historical test data, the target factor among the plurality of the factors by the maximum information coefficient method, comprising:
determining abnormal data in the plurality of the first historical test data by a Grubbs, and removing the abnormal data;
processing the plurality of the first historical test data with the abnormal data removed by a wavelet threshold denoising method to obtain a plurality of first predetermined historical data,
wherein determining, according to the plurality of the first historical test data, the target factor among the plurality of the factors by the maximum information coefficient method comprises:
determining, according to the plurality of the first predetermined historical data, the target factor by the maximum information coefficient method.

4. The method of claim 3, wherein establishing the neural network model of the conversion efficiency comprises:
acquiring a plurality of second historical test data corresponding to the plurality of the first predetermined historical data, the second historical test data being the historical data of the conversion efficiency;
determining an initial neural network model according to the plurality of the first predetermined historical data and the plurality of the second historical test data;
determining whether prediction accuracy of the initial neural network model is less than or equal to a predetermined value; and
optimizing, in the case that the prediction accuracy of the initial neural network model is determined to be less than or equal to the predetermined value, the initial neural network model using an improved locust optimization algorithm until the prediction accuracy of optimized initial neural network model is greater than the predetermined value, the optimized initial neural network model being the neural network model.

5. The method of claim 4, wherein
after acquiring the plurality of the second historical test data corresponding to the plurality of the first predetermined historical data and before determining the initial neural network model, further comprising:
determining abnormal data in the plurality of the second historical test data by a Grubbs, and removing the abnormal data;
processing the plurality of the second historical test data with the abnormal data removed by a wavelet threshold denoising method to obtain a plurality of second predetermined historical data,
wherein determining the initial neural network model according to the plurality of the first predetermined historical data and the plurality of the second historical test data comprises:
determining the initial neural network model according to the plurality of the first predetermined historical data and the plurality of the second predetermined historical data.

6. The method of claim 4, wherein the initial neural network model is a Gated Recurrent Unit (GRU) neural network model.

7. The method of claim 5, after determining the conversion efficiency according to the neural network model and the first test data, further comprising:
processing a plurality of the second predetermined historical data and a plurality of the first predetermined historical data by a Density-Based Spatial Clustering of Applications with Noise (DBSCAN) algorithm, and determining a reference value of the target factor and a reference value of the conversion efficiency;
determining a degree of influence of the target factor on the conversion efficiency according to the reference value of the target factor, the reference value of the conversion efficiency, the first test data and the neural network model; and
determining, according to the degree of influence, a loss reason of the hydrogen production by the wind-solar hybrid electrolysis of the water.

8. A determination apparatus for conversion efficiency of the hydrogen production by the wind-solar hybrid electrolysis of the water, comprising:
a first acquisition unit, configured to acquire first test data of a target factor influencing the conversion efficiency of the hydrogen production by the wind-solar hybrid electrolysis of the water in real time;
an establishing unit, configured to establish a neural network model of the conversion efficiency; and
a first determination unit, configured to determine the conversion efficiency according to the neural network model and the first test data.

9. A determination system for conversion efficiency of the hydrogen production by the wind-solar hybrid electrolysis of the water, comprising:
a determination apparatus, configured to execute the determination method for the conversion efficiency of the hydrogen production by the wind-solar hybrid electrolysis of the water, comprising:
acquiring the first test data of the target factor influencing the conversion efficiency of the hydrogen production by the wind-solar hybrid electrolysis of the water in real time;
establishing the neural network model of the conversion efficiency; and
determining the conversion efficiency according to the neural network model and the first test data;
a database communicatively connected with the determination apparatus, the database being configured to provide data for the determination apparatus and store the conversion efficiency generated by the determination apparatus;
a terminal, configured to send a request, the request at least comprising a request for acquiring the conversion efficiency of the hydrogen production by the wind-solar hybrid electrolysis of the water; and
a server communicatively connected with the terminal and the database respectively, the server being configured to receive the request, acquire the conversion efficiency from the database according to the request, and send the conversion efficiency to the terminal.

10. The determination system of claim 9, before acquiring the first test data of the target factor influencing the conversion efficiency of the hydrogen production by the wind-solar hybrid electrolysis of the water in real time, further comprising:
acquiring a plurality of first historical test data of a plurality of factors influencing the conversion efficiency; and
determining, according to the plurality of the first historical test data, the target factor among a plurality of factors by a maximum information coefficient method.

11. The determination system of claim 10, wherein
after acquiring the plurality of the first historical test data of the plurality of the factors influencing the conversion efficiency and before determining, according to the plurality of the first historical test data, the target factor among the plurality of the factors by the maximum information coefficient method, comprising:
determining abnormal data in the plurality of the first historical test data by a Grubbs, and removing the abnormal data;
processing the plurality of the first historical test data with the abnormal data removed by a wavelet threshold denoising method to obtain a plurality of first predetermined historical data,
wherein determining, according to the plurality of the first historical test data, the target factor among the plurality of the factors by the maximum information coefficient method comprises:
determining, according to the plurality of the first predetermined historical data, the target factor by the maximum information coefficient method.

12. The determination system of claim 11, wherein establishing the neural network model of the conversion efficiency comprises:
acquiring a plurality of second historical test data corresponding to the plurality of the first predetermined historical data, the second historical test data being the historical data of the conversion efficiency;
determining an initial neural network model according to the plurality of the first predetermined historical data and the plurality of the second historical test data;
determining whether prediction accuracy of the initial neural network model is less than or equal to a predetermined value; and
optimizing, in the case that the prediction accuracy of the initial neural network model is determined to be less than or equal to the predetermined value, the initial neural network model using an improved locust optimization algorithm until the prediction accuracy of optimized initial neural network model is greater than the predetermined value, the optimized initial neural network model being the neural network model.

13. The determination system of claim 12, wherein
after acquiring the plurality of the second historical test data corresponding to the plurality of the first predetermined historical data and before determining the initial neural network model, further comprising:
determining abnormal data in the plurality of the second historical test data by a Grubbs, and removing the abnormal data;
processing the plurality of the second historical test data with the abnormal data removed by a wavelet threshold denoising method to obtain a plurality of second predetermined historical data,
wherein determining the initial neural network model according to the plurality of the first predetermined historical data and the plurality of the second historical test data comprises:
determining the initial neural network model according to the plurality of the first predetermined historical data and the plurality of the second predetermined historical data.

14. The determination system of claim 12, wherein the initial neural network model is a Gated Recurrent Unit (GRU) neural network model.

15. The determination system of claim 13, after determining the conversion efficiency according to the neural network model and the first test data, further comprising:
processing a plurality of the second predetermined historical data and a plurality of the first predetermined historical data by a Density-Based Spatial Clustering of Applications with Noise (DBSCAN) algorithm, and determining a reference value of the target factor and a reference value of the conversion efficiency;
determining a degree of influence of the target factor on the conversion efficiency according to the reference value of the target factor, the reference value of the conversion efficiency, the first test data and the neural network model; and
determining, according to the degree of influence, a loss reason of the hydrogen production by the wind-solar hybrid electrolysis of the water.
